(19) United States
(12) Patent Application Publication
(10) Pub. No.: US 2017/0151725 A1
(43) Pub. Date: Jun. 1, 2017

(54) Revolved Waveform Shell Generation Method

(71) Applicant: Nicholas O'Donnell, Bradenton, FL (US)

(72) Inventor: Nicholas O'Donnell, Bradenton, FL (US)

(21) Appl. No.: 14/953,233

(22) Filed: Nov. 27, 2015

(51) Int. Cl. B29C 67/00; B33Y 50/00; B33Y 10/00

(52) U.S. Cl. CPC B29C 67/0088; B29C 67/0059; B33Y 10/00; B33Y 50/00

(57) ABSTRACT

A method for transforming an audio waveform into a three dimensional solid that constitutes a replication of that particular audio waveform.

### CROSS-REFERENCES TO RELATED APPLICATIONS

This application claims priority under 35 U.S.C. §119(e) to U.S. Provisional Application Ser. No. 62/084,611 filed Nov. 26, 2014, by Nicholas O'Donnell, which is incorporated herein by reference in its entirety

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of three dimensional printing, and more particularly to a method for creating a revolved waveform shell which constitutes a three-dimensional representation of an audio wave form.

2. General Background

Sound, by its nature, is ephemeral unless somehow recorded. Many devices exist for the recording and playback of sound files. However, these devices typically are electronic, require electrical power, and are subject to failure over time. And none of these devices transform a recorded sound wave into a three dimensional, physical representation of that sound wave.

Three-dimensional printing is a method for creating three-dimensional objects by depositing or forming thin layers of material in succession on top of each other so as to build up the desired three-dimensional structure. It is sometimes called “Rapid Prototyping and Manufacturing” (RP&M).

There are many items which can be reproduced by three-dimensional printing. The materials used to form the object are generally polymeric in nature. Through the polymer selection process, it is possible to create a final product that is rigid or that is flexible.

### BRIEF SUMMARY OF THE INVENTION

The present invention is a method for transforming an audio waveform, or an image of an audio waveform, into a three dimensional replication of that waveform. Utilizing the present invention, it is possible to obtain an audio recording, transform the audio recording into a waveform, and then transform this waveform into a three dimensional solid that is a three dimensional replication of the original audio waveform. Utilizing the method of the present invention it is possible to transform highly personalized audio recordings into three dimensional solid representations.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a view of an audio waveform and its axis of symmetry;

FIG. 2 is a two dimensional depiction of an audio waveform and averaged curved paths;

FIG. 3 is a two dimensional view of the area between the curved path and replicated curved path;

FIG. 4 is a picture of a revolved waveform shell of the present invention;

FIG. 5 is a picture of a revolved waveform shell of the present invention.

### REFERENCE NUMBERS INCLUDED IN THE DRAWINGS

The below table provides a ready reference for the reference numbers used in the appended drawings and in this specification:

| Ref. No. | Description | Ref. No. | Description |
|---|---|---|---|
| 100 | Audio Waveform | 101 | Line of Symmetry |
| 102 | X-Axis | 103 | Y-Axis |
| 201 | Curved Path | 202 | Replicated Curved |
| | | | Path |
| 301 | X-Y Plane Area | | |

### DETAILED DESCRIPTION OF THE INVENTION THROUGH THE DRAWINGS

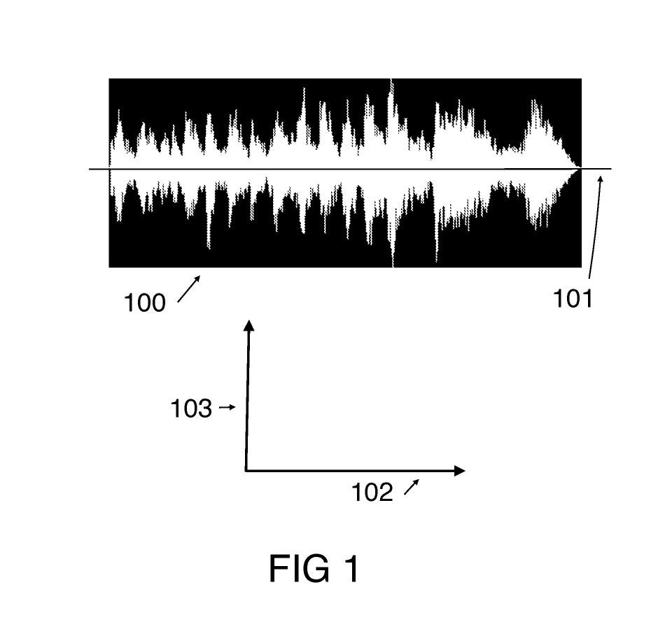

A typical audio waveform 100 is shown in FIG. 1. This is a two-dimensional presentation, with a horizontal, or x-axis 102 component, and a vertical, or y-axis 103 component. Line 101 represents the line of symmetry for the audio waveform 100. The audio waveform 100 has time on the x-axis 102 and sound pressure on the y-axis 101.

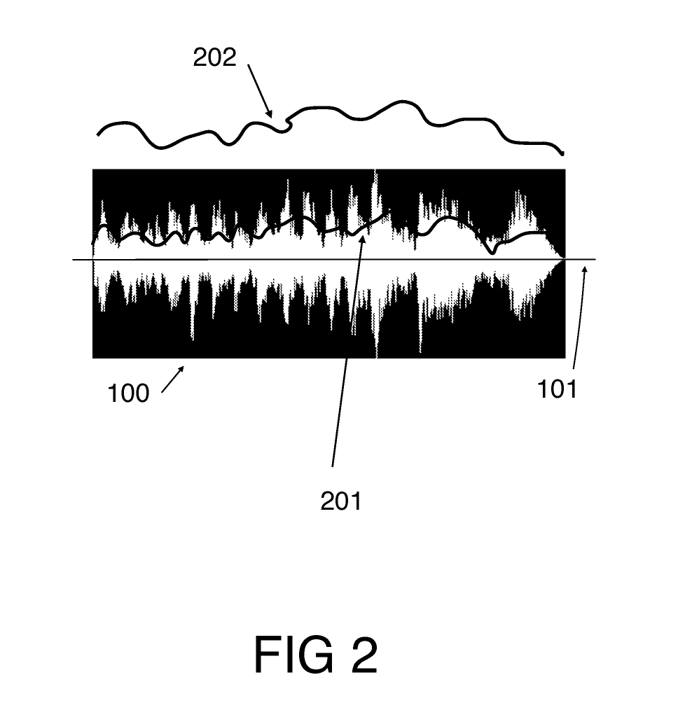

The first step in the process of transforming the two dimensional waveform into a three dimensional replication of that waveform is to import an audio waveform, or an image of an audio waveform, into CAD modeling software. Using the standard pen drawing tool in this software, as shown in FIG. 2, a curved path 201 is traced following the shape of waveform 100. This produces an averaged, but detailed, outline of the curvature of waveform 100.

Next, using an offset command, the curved path 201 is replicated, and located above curved path 201 (in the positive direction in relation to the y-axis 103). Preferably, this replicated curved path 202 is offset 1.5 millimeters above (positive y direction) curved path 201. The replicated curved path 202 is an average of curved path 201, and thus is not an exact replication and contains an averaged, as opposed to identical, representation. The amount of the offset is adjustable to meet the needs of the ultimate product to be produced.

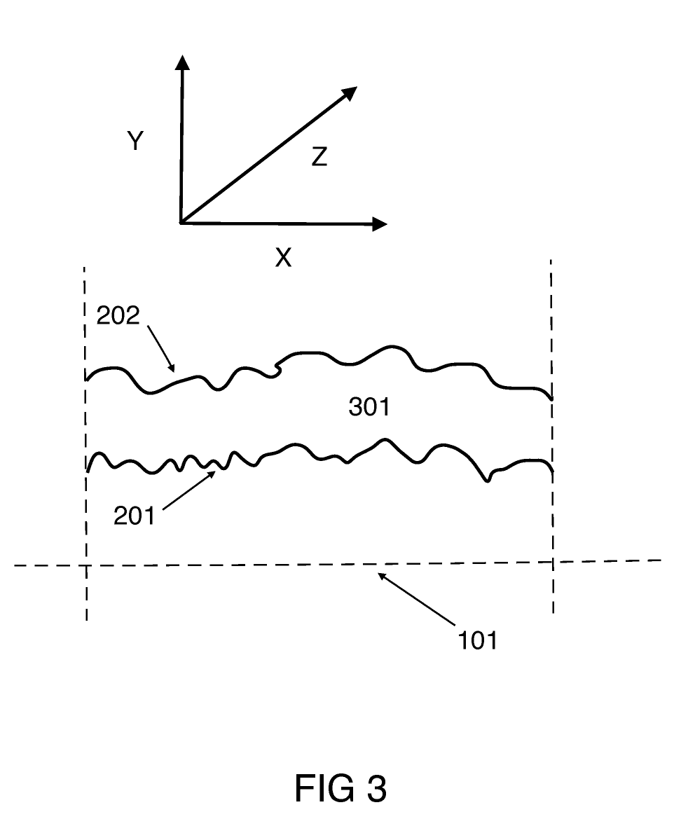

As shown in FIG. 3, the curved path 201 and replicated curve path 202 define an area 301 in the X-Y plane. This area is then rotated about the line of symmetry 101 to create a three-dimensional, manifold cylindrical rendering of the audio waveform. This rendering may then be 3-D printed to create a physical representation of the rendering.

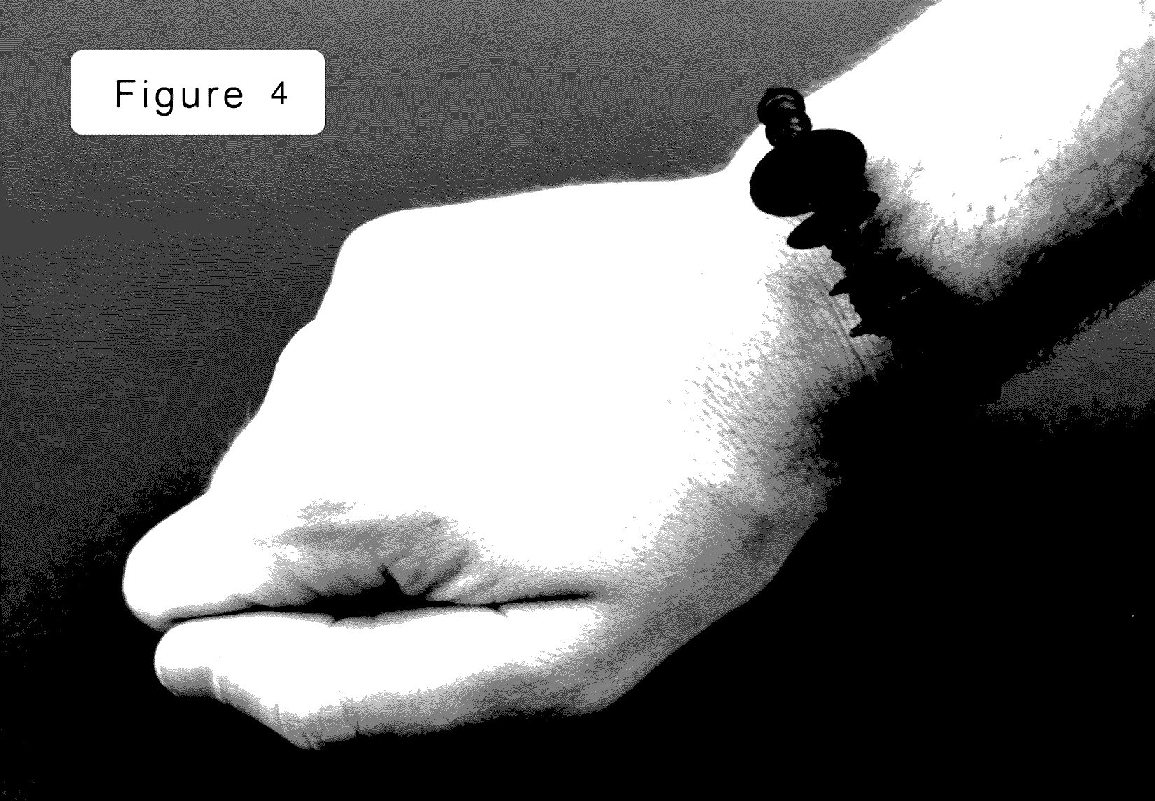

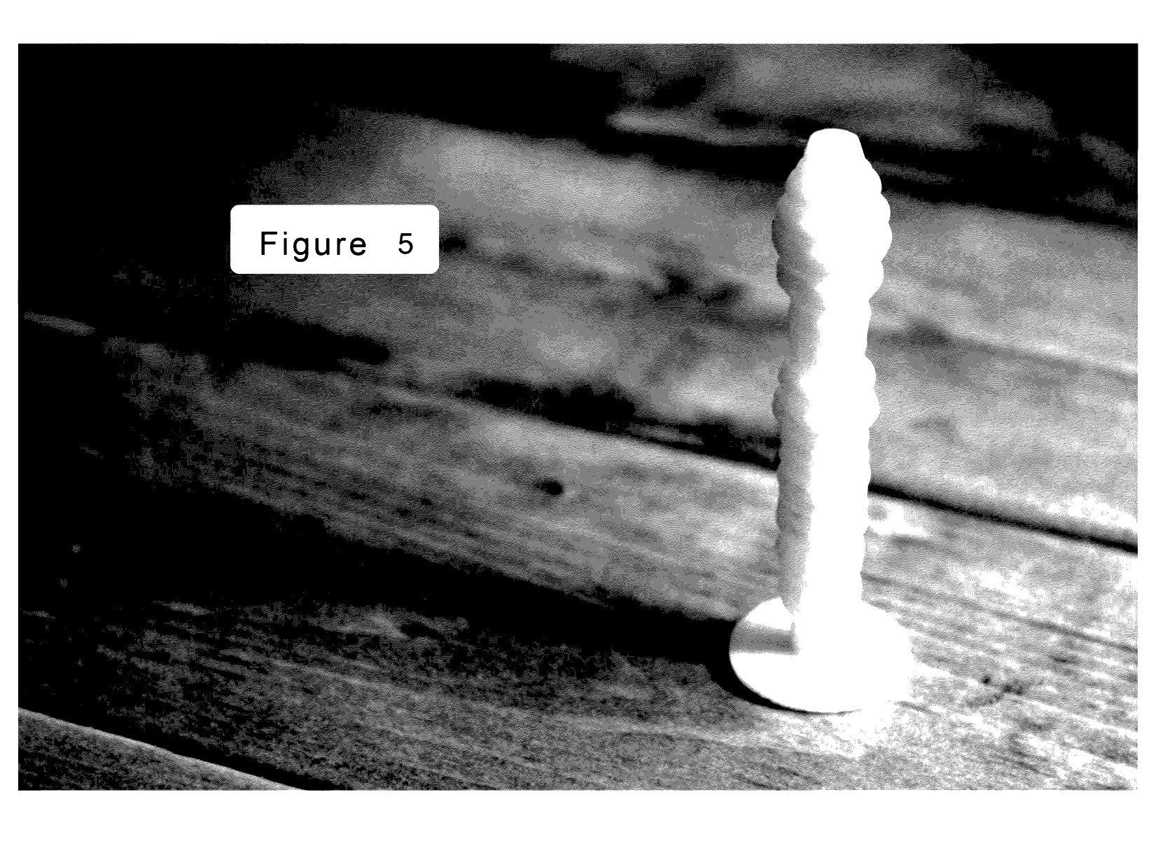

As shown in FIG. 4, the resulting rendering may, in one embodiment, be printed from a flexible material that may be formed as a bracelet. As shown in FIG. 5, the resulting rendering may, in another embodiment, be printed in a more rigid material.

The present invention allows a person to record an audio file, then to transform this audio file into a three dimensional object that replicates the recorded audio file. This allows for highly personalized uses. For example, a husband may record “I love you,” and, using the method of this invention, transform this audio file into a bracelet that his wife may wear.

It will be readily seen by one of ordinary skill in the art that the present invention fulfills all the objects set forth above. After reading the foregoing specification, one of ordinary skill will be able to effect various changes, substation of equivalents and various other aspects of the invention as broadly disclosed herein. It is, therefore, intended that the protection granted hereon be limited only by he definition contained in the appended claims and equivalents thereof.

What is claimed is:

1. A method of creating a revolved waveform comprising:
a. recording an audio waveform;
b. importing said audio waveform into a CAD modeling software program;
c. creating a two dimensional representation of said waveform in said CAD modeling software, wherein time is represented on an x-axis of said two dimensional representation and sound pressure is represented on said y-axis of said two dimensional representation;
d. creating a curved path averaged representation of a curvature of said audio waveform;
e. creating a replicated curved path representation of said curved path averaged representation of a curvature of said audio waveform, and displacing said averaged representation of said averaged representation with respect to said x-axis, thereby creating an area between said curved path and said replicated curved path;
f. rotating said area around a line of symmetry, whereby a three dimensional representation file is created and stored in said CAD modeling software; and
g. printing said three dimensional representation file on a three dimensional printer to create a three dimensional representation of said audio waveform.

2. The method of creating a revolved waveform of claim 1 wherein an image of said waveform is imported into said Cad modeling software.

3. The method of creating a revolved waveform of claim 1 wherein said three dimensional representation of said audio waveform is formed into a bracelet.

4. The method of creating a revolved waveform of claim 1 wherein said three dimensional representation of said audio waveform is formed into a pendant.

5. The method of creating a revolved waveform of claim 1 wherein said three dimensional representation of said audio waveform is formed into a free standing sculpture.

6. The method of creating a revolved waveform of claim 1 wherein said replicated curved path is displaced 1.5 millimeters from said curved path.
